(19) United States
(12) Patent Application Publication
(10) Pub. No.: US 2016/0139306 A1
(43) Pub. Date: May 19, 2016

(54) RETROREFLECTOVE ARTICLE WITH MULTILAYER SEAL FILM

(71) Applicant: 3M INNOVATIVE PROPERTIES COMPANY, Saint Paul, MN (US)

(72) Inventors: Reema Chatterjee, Woodbury, MA (US); Jeffrey O. Emslander, Stillwater, MN (US); Danny L. Fleming, Stillwater, MN (US)

(21) Appl. No.: 14/900,933

(22) PCT Filed: Jun. 10, 2014
(86) PCT No.: PCT/US2014/041654

§ 371 Date: Dec. 22, 2015

Related U.S. Application Data
(60) Provisional application No. 61/838,562, filed on Jun. 24, 2013.

(51) Int. Cl. G02B 5/124; G02B 5/13

(52) U.S. Cl. CPC G02B 5/124; G02B 5/13

(57) ABSTRACT

The present disclosure generally relates to retroreflective articles and methods of making retroreflective articles including a plurality of microreplicated retroreflective elements (prismatic elements and lenslets) and a multilayer seal film adjacent to the retroreflective elements. The multilayer film includes a polymeric sealing layer and an adhesive layer. In some embodiments, the multilayer film includes a release liner. Seal legs extend through all layers of the multilayer film In some embodiments, the retroreflective article is retroreflective sheeting. In some embodiments, the retroreflective sheeting and the multilayer film are laminated, embossed, and/or sealed in a single processing step.

### TECHNICAL FIELD

This disclosure relates generally to retroreflective articles (e.g. sheeting) that include prismatic elements or lenslets and a multilayer seal film. This disclosure also generally relates to methods of making such articles.

### BACKGROUND

Retroreflective articles are characterized by the ability to redirect light incident on the material back toward the originating light source. This property has led to the widespread use of retroreflective articles in sheeting used in, for example, traffic and personal safety uses. Retroreflective sheeting is commonly employed in a variety of traffic control articles, for example, road signs, barricades, license plates, pavement markers and marking tape, as well as retroreflective tapes for vehicles and clothing.

One type of retroreflective sheeting is cube corner sheeting, sometimes referred to as “prismatic” sheeting. Prismatic retroreflective sheeting typically includes a thin transparent layer having a substantially planar first surface and a second structured surface including a plurality of geometric structures, some or all of which include three reflective faces configured as a cube corner element. Prismatic retroreflective sheeting is known for returning a large portion of the incident light towards the source (Smith, K. Driver-Focused Design of Retroreflective Sheeting For Traffic Signs, in Transportation Research Board 87^{th} Annual Meeting: Compendium of Papers DVD, Washington, D.C. 2008). Many commercially available products rely on the relatively high retroreflectance (light return toward the source) provided by prismatic cube corner microstructures to meet high retroreflectance specifications (e.g., retroreflectance (R_{A}) or brightness in the range of 300 to 1000 candela per lux per meter square (cpl) for 0.2 degree observation angle and −4 entrance angle), such as ASTM types III, VII, VIII, IX, and X, as described in ASTM D 4956-04, and type XI. There are various types of prismatic retroreflective sheeting. One such type includes truncated cube corner elements and is described in, for example, U.S. Pat. Nos. 3,712,706; 4,202,600; 4,243,618; and 5,138,488, all of which are incorporated herein in their entirety. Another type includes full cube corner elements, as is described in, for example, U.S. Pat. Nos. 7,156,527; 7,152,983; and 8,251,525, incorporated herein in their entirety.

Another type of retroreflective sheeting is lenslet-based sheeting. In general, lenslet-based sheeting includes a plurality of microlenses that focus and retroreflect incident light. The sheeting typically has a first major surface and an opposing second major surface, one or both of which include lenses. In some embodiments, the lenses are hemi-spheroidal, but other shape lenses can be used. The lenses in lenslet-based sheeting are microreplicated. An exemplary description of lenslet-based sheeting is provided, for example, in U.S. Pat. Nos. 2,951,419; 3,963,309; 5,254,390; and 8,057,980, all of which are incorporated in their entirety herein.

In many instances, it is desirable to seal the retroreflective sheeting and thereby to protect the optical elements (e.g., cube corner elements and lenslets) from environmental degradation. Inclusion of a sealing layer in the sheeting prevents or limits entry of soil or moisture into the sheeting. Some exemplary methods of applying of a sealing layer are described in U.S. Pat. Nos. 7,329,447; 7,611,251; 5,784,197; 4,025,159 (disclosing use of electron beam radiation); U.S. Pat. No. 5,706,132 (use of thermal bonding or radio frequency welding); PCT Publication WO 2011/152977 (describing multi-layer sealing films for prismatic retroreflective sheeting); and. U.S. Pat. No. 6,224,792 (hermetic encapsulation by the sealing layer).

After the sealing process is complete, the sealed back side is then coated with adhesive. Afterwards, a release liner is placed over the adhesive coating. In some instances, the adhesive is coated on a release liner, and the release liner is then laminated to the backside of the retroreflective sheeting.

### SUMMARY

The inventors of the present disclosure recognized that the existing method of sealing, adhesive coating, and release liner coating retroreflective sheeting requires numerous steps. The inventors also recognized that manufacturing efficiency and cost-saving could be achieved by reducing the number of separate steps in manufacturing these articles. To address these problems, the inventors of the present disclosure invented various processes described herein that eliminate the separate adhesive lamination step in making prismatic or lenslet retroreflective articles. At least some of these processes enable direct lamination of a seal film with adhesive (and optionally a release liner) to retroreflective articles in a single step.

Additionally, the inventors of the present disclosure recognized that the existing methods of sealing prismatic and lenslet retroreflective sheeting create air bubbles between the adhesive and the substrate to which the retroreflective sheeting is attached. The inventors of the present application recognized that creating a retroreflective sheeting with the ability to bleed or remove trapped gas or air bubbles could improve the overall performance (e.g., durability, appearance under diffuse light, etc) of the sheeting. The inventors of the present disclosure recognized that one method to create a retroreflective sheeting with air bleed properties involves the inclusion of a multilayer film (including a sealing layer and an adhesive and optionally a release liner) through which seal legs and/or channels are present.

Some embodiments of the present disclosure relate to a retroreflective article, comprising a plurality of microreplicated retroreflective elements that are at least one of (a) prismatic elements or (b) lenslets; and a multilayer film adjacent to the microreplicated retroreflective elements and comprising a polymeric sealing layer and an adhesive layer; and seal legs extending through all layers of the multilayer film.

In some embodiments, the prismatic elements are at least one of truncated cube corner elements, pg cube corner elements, and full cube corner elements. In some embodiments, the microreplicated retroreflective elements are adjacent to at least one of a land layer or a body layer. In some embodiments, the seal legs extend between the multilayer film and at least one of the microreplicated retroreflective elements, the land layer, or the body layer. In some embodiments, the prismatic elements include a thermoplastic polymer. In some embodiments, the thermoplastic polymer is at least one of an acrylic polymer, a polycarbonate, a polyester, a polyimide, a fluoropolymer, a polyamide, a polyetherketone; a poly(etherimide); a polyolefin; a poly(phenylene ether); a poly(styrene); a styrene copolymer; a silicone modified polymer; a cellulosic polymer; a fluorine modified polymer; and mixtures of the above polymers. Some embodiments further include an air interface between at least some of the microreplicated retroreflective elements and the multilayer film.

Some embodiments further include a release liner layer adjacent to the adhesive layer. In some embodiments, the release liner is polymeric. In some embodiments, the release liner is comprised of two layers, a release layer facing the adhesive layer and an outer layer having a composition to reduce blocking. In some embodiments, the release liner comprises a release layer comprised of very low density polyethylene, and an outer layer comprised of a polyethylene that is not very low density polyethylene. In some embodiments, the outer layer includes at least one of polypropylene, polyethylene, or polyethylene terephthalate.

In some embodiments, the polymeric sealing layer includes at least one of a thermoplastic polymer, a heat activated polymer, a polymer composition curable by ultraviolet radiation, and a polymer composition curable by ionizing radiation. In some embodiments, the polymeric sealing layer includes a thermoplastic composition comprising at least 50 weight percent reaction products of an alkylene monomer and reaction products of at least one non-acidic polar monomer, and the thermoplastic composition comprises a polyalkylene modified by an acid, an anhydride, carbon monoxide or a combination thereof.

In some embodiments, the microreplicated retroreflective elements are coated with a specular reflective coating.

Other embodiments relate to a process of making a retroreflective article, comprising: laminating a multilayer film adjacent to a plurality of microreplicated retroreflective elements and thereby forming a plurality of seal legs that extend through all layers of the multilayer film; wherein the multilayer film comprises a polymeric sealing layer and an adhesive layer; and wherein the microreplicated retroreflective elements comprise at least one of prismatic elements and lenslets.

In some embodiments, laminating the multilayer film includes bonding the multilayer film to the plurality of microreplicated retroreflective elements by at least one of ultrasonic, radio frequency welding, thermal bonding, ultraviolet radiation, and electron beam radiation. Some embodiments further comprise using solution casting, extrusion casting, blown film extrusion, or any combination thereof to form the multilayer film. In some embodiments, extrusion casting involves coextrusion casting. In some embodiments, blown film extrusion involves blown film coextrusion.

In some embodiments, the prismatic elements are at least one of truncated cube corner elements, pg cube corner elements, and full cube corner elements. In some embodiments, the microreplicated retroreflective elements are adjacent to at least one of a land layer or a body layer. In some embodiments, the seal legs extend between the multilayer film and at least one of the microreplicated retroreflective elements, the land layer, or the body layer. In some embodiments, the microreplicated retroreflective elements include a thermoplastic polymer. In some embodiments, the thermoplastic polymer is at least one of an acrylic polymer, a polycarbonate, a polyester, a polyimide, a fluoropolymer, a polyamide, a polyetherketone; a poly(etherimide); a polyolefin; a poly(phenylene ether); a poly(styrene); a styrene copolymer; a silicone modified polymer; a cellulosic polymer; a fluorine modified polymer; and mixtures of the above polymers. Some embodiments involve laminating the multilayer film adjacent to the plurality of microreplicated retroreflective elements to form an air interface between at least some of the microreplicated retroreflective elements and the multilayer film.

In some embodiments, the multilayer film further comprises a release liner layer adjacent to the adhesive layer. In some embodiments, the release liner layer is polymeric. In some embodiments, the release liner layer is comprised of two layers, a release layer facing the adhesive layer and an outer layer having a composition to reduce blocking. In some embodiments, the release liner layer comprises a release layer comprised of very low density polyethylene, and an outer layer comprised of a polyethylene that is not very low density polyethylene. In some embodiments, the outer layer includes at least one of polypropylene, polyethylene, or polyethylene terephthalate.

In some embodiments, the polymeric sealing layer includes at least one of a thermoplastic polymer, a heat activated polymer, a polymer composition curable by ultraviolet radiation, or a polymer composition curable by ionizing radiation. In some embodiments, the polymeric sealing layer includes a thermoplastic composition comprising at least 50 weight percent reaction products of an alkylene monomer and reaction products of at least one non-acidic polar monomer, and the thermoplastic composition comprises a polyalkylene modified by an acid, an anhydride, carbon monoxide, or a combination thereof.

In some embodiments, the microreplicated retroreflective elements are coated with a specular reflective coating.

Some embodiments further involve co-extruding the sealing layer and adhesive layer in a single step to form the multilayer film.

Other features and advantages of the present application are described or set forth in the following detailed specification that is to be considered together with the accompanying drawings.

### BRIEF DESCRIPTION OF DRAWINGS

The disclosure may be more completely understood in consideration of the following detailed description of various embodiments of the disclosure in connection with the accompanying drawings.

FIG. 1 is a plan view of exemplary prismatic or lenslet retroreflective sheeting showing an exemplary diamond-shaped seal pattern, not drawn to scale.

FIG. 2 is a cross-sectional representation of an exemplary embodiment of prismatic retroreflective sheeting according to the present disclosure, not drawn to scale.

FIG. 3 is a cross-sectional representation of an exemplary embodiment of prismatic retroreflective sheeting according to the present disclosure, not drawn to scale.

FIG. 4 is a cross-sectional representation of an exemplary embodiment of lenslet retroreflective sheeting according to the present disclosure, not drawn to scale.

FIG. 5 is a cross-sectional representation of an exemplary embodiment of prismatic retroreflective sheeting according to the present disclosure, not drawn to scale.

### DETAILED DESCRIPTION

In the following detailed description, reference may be made to the accompanying drawing that forms a part hereof and in which is shown by way of illustration one exemplary specific embodiment. It is to be understood that other embodiments are contemplated and may be made without departing from the scope or spirit of the present disclosure.

The concepts described herein are applicable to any sealed and adhesive-coated retroreflective article having prismatic cube corner elements or lenslets. The following discussion will relate to retroreflective sheeting (one exemplary set of embodiments of these retroreflective articles). But the disclosure is meant to include non-sheeting retroreflective articles as well.

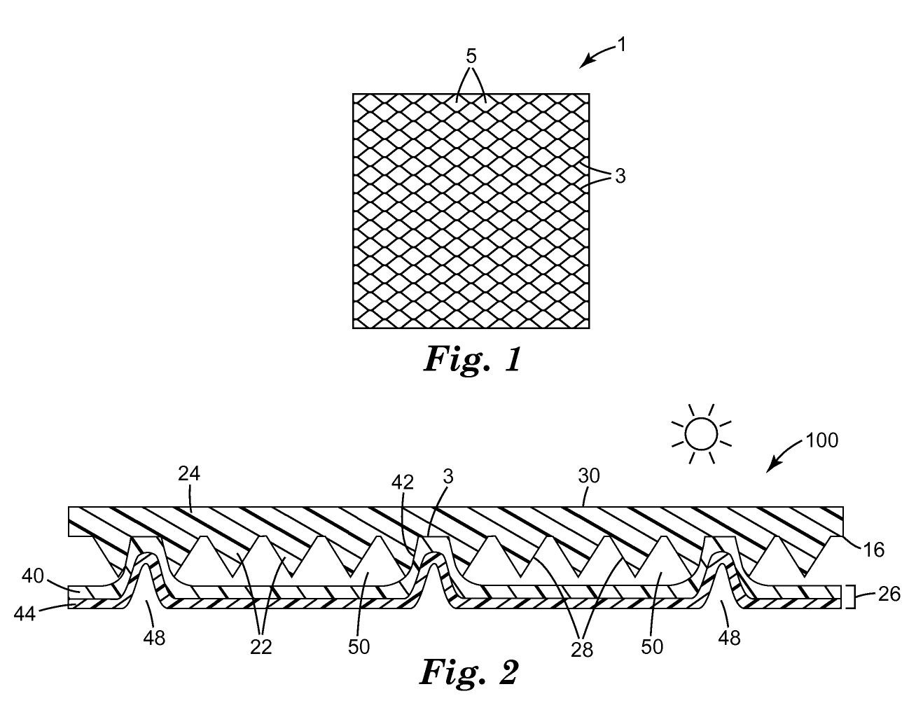

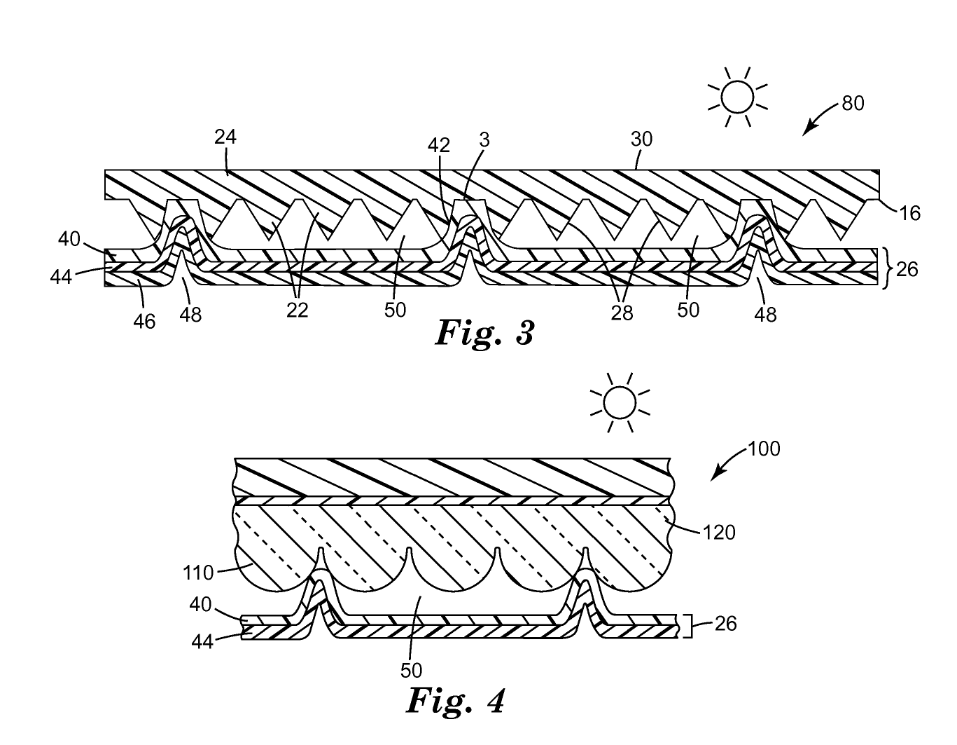

FIG. 1 shows a top view of an exemplary retroreflective article 1 in which a seal pattern 3 is visible. Seal pattern 3 forms cells 5 in a diamond-shaped grid pattern. The specific seal pattern shown in FIG. 1 is merely exemplary. The cells may be in any of a variety of shapes, such as triangles, hexagons, diamonds, rectangles, parallelograms, other polygons or curved shapes. The seal pattern may be any arrangement or pattern (regular or random). In some embodiments, the seal pattern includes lines (straight or curved) that form cells enclosing a plurality of retroreflective lens elements. In some embodiments, the seal pattern includes microsealed cell geometries, shapes, sizes and structures, such as those described in, for example, U.S. Patent Publications Nos. 2013/0135731, and 2013/0114142 (see, for example, FIGS. 3, 4, 6, 8 and 9, and paragraphs [0063], [0065] [00144] [00159] [00160]), both of which are incorporated herein in their entirety by reference.

Seal pattern 3 includes a plurality of individual seal legs that extend between the microreplicated retroreflective elements (e.g., prismatic elements or lenslets) and a multilayer seal film. In some embodiments, these seal legs form one or more cells 5. A low refractive index material (e.g., a gas, air, aerogel, or an ultra low index material described in, for example, U.S. Patent Publication Nos. 2010-0265584) can be enclosed in each cell 5. The presence of the low refractive index material creates a refractive index differential between the microreplicated retroreflective elements and the low refractive index material. This permits total internal reflection at the surfaces of the microreplicated retroreflective elements. In embodiments where air is used as the low refractive index material, the interface between the air and the microreplicated retroreflective elements is often referred to as an air interface.

FIG. 2 shows an exemplary embodiment of a retroreflective article 20 consistent with the teachings herein. Retroreflective article 20 includes microreplicated retroreflective elements in the form of prismatic cube corner elements 22 (adjacent to a body layer 24) adhered, bonded, and/or adjacent to a multilayer film 26. Cube corner elements 22 form a structured surface 28 that is opposite a major surface 30 (sometimes referred to as a front side surface because light rays are incident on surface 30) of body layer 24. Multilayer film 26 includes a sealing layer 40 and an adhesive layer 44. Multilayer film 26 is adhered and/or bonded to one or more of structured surface 28 or body layer 24 or a land layer (not shown). The areas in which multilayer film 26 is adhered and/or or bonded (e.g., by embossing) to structured surface 28 or body layer 24 or a land layer form seal legs 42, and in some instances, channels 48.

In some embodiments, seal legs 42 are disposed between multilayer film 26 (e.g., sealing layer 40) and at least one of (1) structured surface 28 of cube corner elements 22, (2) the land layer, and/or (3) body layer 24. In some embodiments, seal legs 42 are formed between sealing layer 40 and body layer 24. In some embodiments, seal legs 42 are formed between sealing layer 40 and a land layer. In some embodiments, seal legs 42 are formed between sealing layer 40 and structured surface 28 of cube corner elements 22. In some embodiments, seal legs 42 are formed between a combination of (1) structured surface 28 of cube corner elements 22, (2) the land layer, and/or (3) body layer 24. In other words, one seal leg may be formed between sealing layer 40 and body layer 18 and an adjacent seal leg formed between sealing layer 40 and a land layer and an adjacent seal leg formed between sealing layer 40 and structured surface 28. It is within the scope of the present application to have different seal legs in a single piece of sheeting formed between different ones of (1) structured surface 28 of cube corner elements 22, (2) the land layer, and/or (3) body layer 24. As such, the retroreflective sheeting can include more than one type of seal legs.

Seal legs bond the multilayer film to at least one of the microreplicated retroreflective elements, body layer, and/or land layer. In some embodiments, seal legs 42 assist in, for example, creating and maintaining a cell, air gap, and/or air interface 50 between structured surface 28 and multilayer film 26. In some embodiments, the seal legs assist in preserving the air spaces around the microreplicated retroreflective elements. In some embodiments, the microreplicated retroreflective elements in each cell are hermetically encapsulated by the sealing layer 40 of multilayer film 26 by the application of heat and pressure or other techniques, see e.g., U.S. Pat. No. 6,224,792, incorporated herein in its entirety. In other embodiments, the seal legs help to protect the microreplicated retroreflective elements from environmental degradation by preventing or limiting entry of soil or moisture into the cells. In some embodiments, the seal legs do not form cells or air interfaces.

In the embodiment shown in FIG. 2, seal legs 42 include all of the layers of multilayer film 26. This is because the process of bonding and/or embossing the multilayer film is applied to all layers of the multilayer film such that the seal pattern is, for example, pressed through all the layers of the multilayer film as shown by the shape of the channels 48 and/or seal legs 42. In some embodiments, when the front side surface of the retroreflective article is viewed from above (in top view), seal legs 42 form an overall seal pattern in the final retroreflective article that, in some embodiments, may be visible to the naked eye.

Where present, the seal pattern can be any desired pattern, design, or arrangement. In some embodiments, the pattern or design or arrangement is random. In some embodiments, the pattern or design or arrangement is organized or repeating. Some exemplary seal patterns include those described in, for example, PCT Patent Application No. PCT/US2010/031298 (see, e.g., FIGS. 3, 4, 6, 8, 9 and paragraphs [0063], [0065], [00144], [00159], and [00160]), the entirety of which is incorporated herein by reference.

In some embodiments, the adherence or bond between multilayer film 26 and at least one of structured surface 28, body layer 24, or a land layer (not shown) forms a channels 48, which is a physical groove or depression in at least a portion of the multilayer film. Where channels 48 are present, they can permit or facilitate air egress (which may be called fluid exhaust or air bleed) from beneath the retroreflective sheeting when the sheeting is applied to a substrate. This can help in reducing deformities in the applied sheeting such as air pockets, bubbles, or wrinkles. In some embodiments, the adhesive layer is not so aggressive or tacky that the adhesive in the channels bonds quickly to a substrate interfering with air egress (or fluid exhaust) from between the retroreflective article being applied and the substrate to which it is being adhered. In some embodiments, channels 48 are continuous (i.e., connected to at least one other channel). In some embodiments, each channel 48 is connected to many channels. In some embodiments, channels 48 are all connected. In some embodiments, the channels are not connected. Some exemplary channel depth ranges are 3-45 micrometers (μm), 5-25 μm, and not more than 10 μm deep. Some exemplary channel width ranges are 15-250 μm and 15-30 μm. In some embodiments where channels are formed for the purpose of fluid exhaust or air egress, the wider the channels are, the less deep they have to be, and vice versa.

In at least some embodiments, the areas of the multilayer film into which channels 48 are impressed do not recover their original or flat shape, and channels 48 remain present over time. In some embodiments, the areas of the release liner layer into which channels are impressed recover their original or flat shape after some amount of time has passed.

FIG. 3 shows another exemplary embodiment of a retroreflective article 80 consistent with the teachings herein. Retroreflective article 80 includes microreplicated retroreflective elements in the form of prismatic cube corner elements 22 (adjacent to a body layer 24) adhered, bonded, and/or adjacent to a multilayer film 26. The embodiment shown in FIG. 3 is the same as that shown in FIG. 2 except that multilayer film 26 includes a release liner 46 in addition to sealing layer 40 and adhesive layer 44. In the embodiment shown in FIG. 3, seal legs 42 include all of the layers of the multilayer film. This is because the process of bonding or embossing the multilayer film is applied to all layers of the multilayer film such that the seal pattern is, for example, pressed through all the layers of the multilayer film as shown by the shape of the channels 48 and seal legs 42.

FIG. 4 shows another exemplary embodiment of a retroreflective article 100 consistent with the teachings herein. Retroreflective article 100 includes microreplicated retroreflective elements in the form of lenslets 110 (adjacent to a land layer 120) adhered, bonded, and/or adjacent to a multilayer film 26. The embodiment shown in FIG. 4 is the same as that shown in FIG. 2 except that the microreplicated retroreflective elements are lenslets 110 instead of cube corner elements 22. The specific embodiment shown in FIG. 4 does not include a release liner, but a release liner could be included as generally shown in FIG. 3.

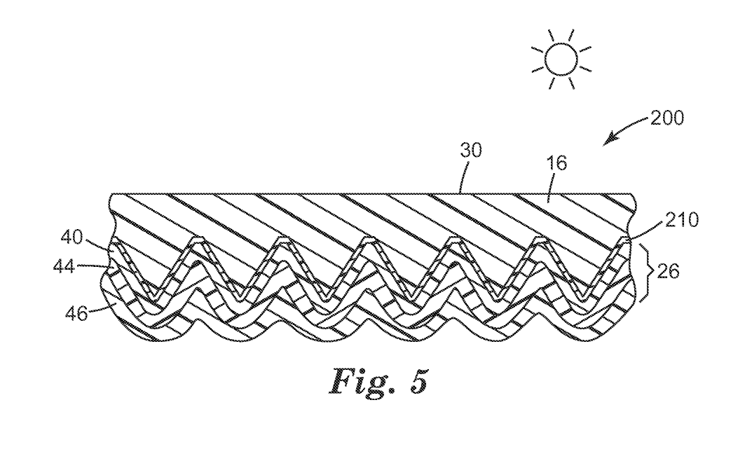

FIG. 5 shows another exemplary embodiment of a retroreflective article 200 consistent with the teachings herein. Retroreflective article 200 includes metallized prismatic sheeting. More specifically, retroreflective article 200 includes microreplicated retroreflective elements in the form of prismatic cube corner elements 22 (adjacent to a body layer 24) adhered, bonded, and/or adjacent to a multilayer film 26. Cube corner elements 22 form a structured surface 28 that is opposite a major surface 30 (sometimes referred to as a front side surface because light rays are incident on surface 30) of body layer 24. A specular reflective coating 210 is directly adjacent to prismatic cube corner elements 22. Because retroreflection is caused by the specular reflective coating, an air interface is not required to create retroreflection (but may be present). As such, the layers of multilayer film 26 (sealing layer 40 and adhesive layer 44) generally follow the structure of prismatic cube corner elements 22. Multilayer film 26 is adhered and/or bonded to one or more of structured surface 28 or body layer 24 or a land layer (not shown). The areas in which multilayer film 26 is adhered and/or or bonded (e.g., by embossing) to structured surface 28 or body layer 24 or a land layer form seal legs 42, and in some instances, channels 48.

Microreplicated Retroreflective Elements

The microreplicated retroreflective elements used in the articles and methods described herein can be prismatic cube corner elements or lenslets. In some embodiments, the microreplicated retroreflective elements used in the articles and methods described herein include light transmitting or transparent polymeric materials.

There are various types of prismatic retroreflective elements that can be used in the embodiments and inventions described and claimed herein. One such type includes truncated cube corner elements including, for example, those described in U.S. Pat. Nos. 3,712,706; 4,202,600; 4,243,618; and 5,138,488, all of which are incorporated herein in their entirety. Other types include PG cube corner elements and full cube corner elements, as is described in, for example, U.S. Pat. Nos. 7,156,527; 7,152,983; and 8,251,525, all of which are incorporated herein in their entirety. As used herein, the term “PG cube corner elements” or “preferred geometry cube corner elements” refers to a cube corner element that has at least one non-dihedral edge that: (1) is nonparallel to the reference plane; and (2) is substantially parallel to an adjacent non-dihedral edge of a neighboring cube corner element. A cube corner element whose three reflective faces comprise rectangles (inclusive of squares), trapezoids or pentagons are examples of PG cube corner elements. “Reference plane” with respect to the definition of a PG cube corner element refers to a plane or other surface that approximates a plane in the vicinity of a group of adjacent cube corner elements or other geometric structures, the cube corner elements or geometric structures being disposed along the plane. In the case of a single lamina, the group of adjacent cube corner elements consists of a single row or pair of rows. In the case of assembled laminae, the group of adjacent cube corner elements includes the cube corner elements of a single lamina and the adjacent contacting laminae. In the case of sheeting, the group of adjacent cube corner elements generally covers an area that is discernible to the human eye (e.g., preferably at least 1 mm²) and preferably the entire dimensions of the sheeting.

Materials and methods of construction useful for forming the cube corner elements include, for example, those described in U.S. Pat. No. 7,862,187, incorporated herein in its entirety. In some embodiments, the cube corner, prismatic elements include thermoplastic polymers. Some exemplary thermoplastic polymers include acrylic polymers (such as poly(methyl methacrylate)), polycarbonates, polyesters (polyethylene terephthalate), polyimides, fluoropolymers (poly(vinylidene fluoride)), polyamides, polyetherketones; poly(etherimides); polyolefins such as poly(methylpentene); poly(phenylene ether); poly(styrene);styrene copolymers; silicone modified polymers; cellulosic polymers (e.g., cellulose acetate); fluorine modified polymers (e.g., perfluoropoly(ethyleneterephthalate); and mixtures of the above polymers. They may also be made of a polymer composition that can be cross-linked, cured or thermoset (e.g., by exposure to actinic radiation or heat) such as an acrylate resin curable by ultraviolet radiation, visible light or electron beam radiation. Examples of such resins are in U.S. Pat. Nos. 7,611,251 and 7,862,187, both of which are incorporated herein in their entirety. In some embodiments, the cube corner elements include at least 2 wt-% of a polymerizable amine-containing ingredient that includes a (meth)acrylate functionality Amine-containing monomers useful in making such resins include diethylaminoethyl(meth)acrylate, dimethylaminoethyl(meth)acrylate and mixtures thereof. Such monomers can be mixed (and cured) with epoxy(meth)acrylate resins as taught in the examples of the '187 patent. In some embodiments, the prismatic cube corner elements have a height ranging from 20 to 500 micrometers (μm).

In general, lenslet-based sheeting includes a plurality of microlenses that focus and retroreflect incident light. The sheeting typically has a first major surface and an opposing second major surface, one or both of which include lenses. An exemplary description of lenslet-based sheeting is provided, for example, in U.S. Pat. Nos. 2,951,419; 3,963,309; 5,254,390; and 8,057,980, all of which are incorporated in their entirety herein. The specific embodiment shown in FIG. 4 includes lenses on one major surface, but the scope of the present disclosure includes embodiments including lenslets on both major surfaces. In some embodiments (including the one shown in FIG. 4), the lenses are hemi-spheroidal, but other shape lenses can be used. The lenses in lenslet-based sheeting are microreplicated. In some embodiments, the lenslets are vapor coated and/or include a specular reflective coating.

Body Layer:

As used herein, the term “body layer” refers to a separate material to which the microreplicated elements are attached, adhered, or adjacent (see, for example, FIG. 2). A body layer is optional. In some embodiments, microreplicated retroreflective elements of the types described herein are adhered, attached, or adjacent to a body layer. Some exemplary body layers have a thickness between about 20 and 1,000 μm. In some embodiments, both the body layer and microreplicated retroreflective elements include the same material. In some embodiments, the material is one or more light transmitting or transparent polymeric materials. In some embodiments, the body layer is a different material(s) than the microreplicated retroreflective elements. In some embodiments, the body layer may itself include more than one layer. In some embodiments where the body layer includes multiple layers, these layers can include more than one composition, and the composition can vary by layer. Some exemplary body layers are described in, for example, U.S. Pat. No. 7,611,251, incorporated by reference herein in its entirety. These materials include, for example, poly(ethylene-co-acrylic acid), poly(ethylene-co-vinylacetate), PVC (poly vinyl chloride), PET (polyethylene terephthalate), polycarbonate, acrylic, and polyurethane. In some embodiments, the body layer includes a polyolefin, typically comprising at least 50 weight percent (wt-%) of alkylene units having 2 to 8 carbon atoms (e.g., ethylene and propylene).

Land Layer:

As used herein, the term “land layer” refers to a material adjacent to and integral with the microreplicated elements. A land layer is optional. Some embodiments include a land layer (not shown) integral with cube corner elements 12 which is includes the same polymeric material as the cube corner elements. Cube corner retroreflective sheeting having a land layer is shown, for example, in U.S. Pat. No. 5,450,235, which is incorporated herein in its entirety. In some embodiments, the land layer is thin by comparison to the microreplicated retroreflective elements, typically having a thickness no greater than 10 percent of the height of the cube corner elements. In some embodiments, land layer thickness is in the range of 1-150 μm. In some embodiments, land layer thickness is in the range of 10-100 μm.

Some embodiments include microreplicated retroreflective elements and a body layer without a land layer. Some embodiments include microreplicated retroreflective elements and a land layer without a body layer. Some embodiments include microreplicated retroreflective elements adjacent to a land layer which is adjacent to a body layer. In this latter instance, the body layer is often referred to as a top film or overlaminate.

Multilayer Seal Film:

The multilayer film includes more than one layer and is attached or adhered to portions of the retroreflective elements, land layer, and/or body layer. The multilayer film includes at least a sealing layer and an adhesive layer. In some embodiments, at least these two layers of the multilayer film are bonded, adhered, and/or embossed to a portion of the structured surface, microreplicated retroreflective elements, land layer, and/or body layer. In some embodiments, the layers of the multilayer film are capable of retaining the deformation from the lamination or embossing tool. The multilayer film may optionally include one or more additional layers, such as, for example, a release liner.

In some embodiments, the multilayer film includes the layers described in, for example, PCT Publication WO 2011/091132 (incorporated herein in its entirety) with specific reference to FIG. 2 and related description as the sealing layer, adhesive layer 28, and the release and liner layers 30 and 32. In some embodiments, the multilayer film includes the layers described in WO 2011/091132 with specific reference to film 20 with a sealing layer instead of a receptor layer 22. In such instances, the sealing layer would be on core layer 24, and primer layer 26 is on core layer 24, opposite sealing layer. Multilayer film 20 from WO 2011/091132 additionally includes: an adhesive layer 28 on primer layer 26 opposite core layer 24; release layer 32 on adhesive layer 28 opposite primer layer 26; and liner layer 32 on release layer 30 opposite adhesive layer 28. The multilayer film can generally be separated along the interface between adhesive layer 28 and release layer 30.

In some embodiments, the multilayer film can be made by methods known in the art such as lamination, co-extrusion and casting a multilayer film from a multilayer die, or co-extrusion through a multilayer blown film die or solvent or extrusion casting the adhesive and seal layers onto a release liner, or any combination of these steps or methods. In some embodiments, the process of making the multilayer film includes using solution casting, extrusion casting, blown film extrusion, or any combination thereof to form the multilayer film. In some embodiments, extrusion casting involves coextrusion casting. In some embodiments, blown film extrusion involves blow film coextrusion.

Sealing Layer:

In some embodiments, the sealing layer is a layer within the multilayer film. The sealing layer is generally useful for sealing the multilayer film to or with the microreplicated retroreflective elements (or body layer or land layer). In some embodiments, sealing layer 40 is sufficiently thick to effectively seal the microreplicated retroreflective elements in the cells formed by the seal legs but not so thick that it impedes embossing or edge sealing of the retroreflective article. An exemplary thickness range is about 0.03 mm to about 0.3 mm. In some embodiments, no cells are formed, and the sealing layer generally follows the shape or structure of the microreplicated elements.

In some embodiments, the sealing layer includes a polymeric composition that can bond and seal well to at least one of the cube corner elements (and/or structured surface thereof), the body layer, and/or the land layer. In some embodiments, the sealing layer includes at least one of a thermoplastic, a heat-activated polymer, an ultraviolet radiation cured polymer, and/or a polymer cured by ionizing radiation such as, for example, electron beam radiation.

In embodiments where the sealing layer includes a thermoplastic, the sealing layer can include, for example, polyether, polyester, polyamide, ionomeric ethylene copolymer, polyolefin, poly-EPDM (ethylene-propylene-diene), styrene acrylonitrile copolymer, plasticized vinyl halide polymer, ABS copolymer or mixtures thereof) or may comprise a curable (cross-linkable) polymer such as those taught in U.S. Pat. No. 4,025,159, incorporated herein in its entirety. Some additional exemplary sealing layer materials are acrylic-based polymeric materials (e.g., acrylate or methylacrylate polymers or copolymers, polyethylene glycol diacrylates and hydroxymethyl diacetone acrylamide); and co-polyethylene terephthalate (COPET). Some additional exemplary sealing layer materials are described in, for example, U.S. Pat. No. 7,611,251, incorporated herein in its entirety. Some embodiments include a sealing layer including a thermoplastic comprising at least 50 wt-% reaction products of an alkylene monomer and reaction products of at least one non-acidic polar monomer, wherein the thermoplastic is modified by an acid, an anhydride, carbon monoxide, and/or a combination thereof. Some exemplary suitable copolymers for the sealing layer include copolymers of ethylene with vinyl acetate (EVA), acid- or anhydride-modified EVA's.

In some embodiments, the sealing layer material(s) softens sufficiently to flow under pressure at, for example, 75°-95° C. but remains substantially firm at temperatures below, for example, about 65° C. Some embodiments of the multilayer sealing film have a melt flow index of less than 25 g/10 min. as measured according to ASTM 1238.

In some embodiments, the sealing layer may itself comprise more than one layer. Such sealing films are taught in, for example, PCT publication WO 2011/152977 (incorporated herein in its entirety). In some embodiments, the multilayer sealing layer includes a first layer including a thermoplastic including reaction products of at least 50% of an alkylene and less than 25% non-acidic comonomer and a second layer including at least one of a polyolefin (e.g., polypropylene or high density polyethylene (HDPE)) and/or a polyester (e.g., polyethylene terephthalate (PET)), polymethyl methacrylate, polyamide, polycarbonate, ethylene-methacrylic acid copolymer, and/or polyurethane).

In some embodiments, the sealing layer includes colorants (e.g., whitening pigment such as titanium dioxide). If one layer of a multilayer sealing layer is pigmented, while another is transparent or clear, the transparent or clear layer may be closer to the microreplicated retroreflective elements than the pigmented layer in laminating the sealing film to the microreplicated retroreflective elements.

Adhesive Layer:

An adhesive layer also can be disposed behind the microreplicated retroreflective elements or the seal film to enable the retroreflective sheeting to be secured to a substrate. The adhesive layer may include any adhesive selected from a variety of formulations known in the art to achieve the desired combination of surface configuration and adhesion to a substrate. Examples include pressure sensitive adhesives (PSA's), including, for example, those described in U.S. Pat. Nos. 5,296,277; 5,362,516; and 5,141,790 and Satas, et. Al., Handbook of Pressure Sensitive Adhesives, 2^{nd} Ed. (Von Nostrand Reihnold, N.Y., 1989), all of which are incorporated by reference in their entirety. Additional exemplary adhesives include, for example, hot melt or heat activated adhesives that are pressure sensitive at the time of application such as PSA's disclosed in, for example, U.S. Pat. Nos. 4,994,322 and 4,968,562 as well as EPO Publication Nos. 540,515 and 617,708, all of which are incorporated herein in their entirety. Additional exemplary adhesives include, for example, a thermoplastic acrylic polymer, for example, an acid functional acrylic polymer. In some embodiments, the acid functional acrylic polymer includes about 10% acid (e.g., acrylic acid). One exemplary PSA composition includes a copolymer of isooctylacrylate and acrylic acid in a molar ratio of 95:5. Additional exemplary PSA compositions include cross-linked, tackified acrylic PSA's, blends of natural or synthetic rubber and resin, silicone or other polymeric compositions.

Chemistry and physical properties of the adhesive can be used to control the length of time the impression of the network of bonds (seal legs) will last in the adhesive layer after the release liner layer is removed. Understanding the rheological properties, such as creep resistance, of an adhesive can assist in controlling how quickly or if the channels may close after removal of the release liner layer and application of the adhesive-backed, retroreflective article to a substrate.

Various additives such as chain transfer agents, colorants (e.g., dyes), antioxidants, light stabilizers, UV absorbers, processing aids (such as anti-blocking agents), release agents, lubricants, and other additives may be added to the body layer 18, the cube corner elements 12, the land layer, or the multilayer film 50, see, for example, U.S. Pat. No. 5,450,235, incorporated in its entirety herein.

Release Liner:

Some embodiments include a release liner. Some embodiments do not include a release liner. For example, in some embodiments wherein the adhesive layer includes a PSA, a release liner may or may not be present. In some embodiments, the adhesive layer in not a PSA. In such embodiments, a release liner may or may not be present. In some embodiments, the adhesive is, for example, a hot melt (heat activated) adhesive. In some implementations of these embodiments, the multilayer sheet may include a sealing layer and adhesive without a release liner.

In some embodiments, the release liner (where present) includes a deformable polymer composition or metal foil, which performs at least one of the following: (1) it can be embossed to form the seal legs, (2) it will release from an embossing tool or roll, and (3) it will release from the adhesive layer so that the retroreflective article can be adhered to a substrate, such as a sign substrate. The release liner composition adequate for release from the adhesive may vary depending on the adhesive composition. In some embodiments, the release liner includes a blend of materials.

Exemplary release liner materials include, for example, polymeric materials or a metal foil. Some exemplary polymeric release liner materials include, for example, thermoplastics such as polyolefins (e.g., polypropylene, low density polyethylene, very low density polyethylene, and high density polyethylene), styrene copolymers, ethylene vinyl acetate polymers, polyurethanes, polydiorganosiloxane polyoxamide copolymers, polyesters (e.g., polyethylene terephthalate), copolyesters, polyvinyl chloride, Bynel acid/acrylate modified ethylene vinyl acetate polymers and Nucrel ethylene (meth)acrylic acid copolymers from E.I. DuPont de Nemours and Company, Wilmington, Del., Moplen HL 456J polypropylene composition from LyondellBasell Industries N.V., Houston, Tex., and Vistamaxx polypropylene based elastomer available from Exxon Mobil Corporation, Houston, Tex. Paper would not be a good choice for the release liner because of its relative inability to deform and withstand the process to form the seal legs.

In some embodiments, the release liner is made of multiple layers. In some embodiments, the multiple layers are coextruded. For example the release liner may include two layers—(1) a release layer (e.g., very low density polyethylene) facing the adhesive layer and (2) an outer layer having a composition to reduce blocking (e.g., not very low density polyethylene). As used herein, the term “blocking” refer to an undesired adhesion between touching layers of a product (e.g., retroreflective sheeting that is rolled upon itself during storage). In some embodiments, very low density polyethylene has a density of less than 0.900 g/cm². In some embodiments, very low density polyethylene has a density of less than 0.890 g/cm². In some embodiments, very low density polyethylene has a density of less than 0.880 g/cm². In some embodiments, the outer layer includes at least one of polypropylene, polyethylene, or polyethylene terephthalate.

An exemplary polymer for use in a release liner made via co-extrusion is a plastomer, such as, for example, copolymers of ethylene and alpha-olefins having 3 to about 10 carbon atoms and a density no greater than 0.91 g/cc. or no greater than 0.89 g/cc (e.g., 1-butene, 1-hexene, 1-octene and combinations thereof). Copolymers of ethylene and 1-octene (block or random copolymers) are preferred for use with acrylate-based PSA's. Some useful copolymers are Infuse™ olefin block copolymers from Dow Chemical Company, Midland, Mich. and Exact™ ethylene alpha olefin copolymers from ExxonMobil. The release liner layer can include the layers described in PCT Publication WO 2011/091132 (which is incorporated herein in its entirety) as a release layer 30 (which can comprise a plastomer, e.g., a copolymer of ethylene and alpha-olefin such as 1-butene) and liner layer 32 (which can comprise a polyolefin, e.g., high density polyethylene and which can comprise more than one layer).

The release liner layer may be coated with one or more release agents such as silicone-based resins, urethanes, long chain acrylates, and fluorine-containing resins. Suitable release agents are described in, for example, U.S. Pat. Nos. 3,957,724; 4,567,073; and 5,290,615, and U.S. Patent Publication No. 2011/244226, all of which are incorporated herein in their entirety.

In at least some embodiments, the areas of the release liner layer into which channels are impressed do not recover their original or flat shape. In some embodiments, the areas of the release liner layer into which channels are impressed do recover their original or flat shape.

Metallized Sheeting

Some embodiments include a specular reflective coating, such as a metallic coating, on the backside of the prismatic or lenslet elements. These embodiments are often referred to as “metallized retroreflective sheeting.” The specular reflective coating can be applied by known techniques such as vapor depositing or chemically depositing a metal such as aluminum, silver, or nickel. A primer layer may be applied to the backside of the cube-corner elements to promote the adherence of the metallic coating. Additional information about metallized sheeting, including materials used to make metallized sheeting and methods of making it can be found, for example, in U.S. Pat. Nos. 4,801,193 and 4,703,999, both of which are incorporated herein in their entirety.

In some embodiments, a separate overlay film is on the viewing surface of the sheeting. The overlay film can assist in providing improved (e.g., outdoor) durability or to provide an image receptive surface. Indicative of such outdoor durability is maintaining sufficient brightness specifications such as called out in ASTM D49560-1a after extended durations of weathering (e.g., 1 year, 3 years). In some embodiments, the CAP-Y whiteness is greater than 30 before and after weathering (e.g., 1 year, 3 years).

Some exemplary substrates to which the retroreflective sheeting can be adhered include, for example, wood, aluminum sheeting, galvanized steel, polymeric materials (e.g., polymethyl methacrylates, polyesters, polyamids, polyvinyl fluorides, polycarbonates, polyvinyl chlorides, polyurethanes), and a wide variety of laminates made from these and other materials.

Some embodiments of the present disclosure are made by the following method: the microreplicated retroreflective elements and the multilayer film are brought together in a lamination process between an embossing tool (e.g., laminating roll) having a raised pattern in the desired seal pattern shape and a nip roll (or other means of providing pressure against the structured surface of the microreplicated retroreflective elements and multilayer film) under conditions of controlled pressure and temperature. Bonding and sealing between the sealing layer and the microreplicated retroreflective elements can be effected by thermal bonding, ultrasonic welding, ultraviolet radiation, ionizing radiation (such as, for example, electron beam radiation), radio frequency welding, and/or reactive components that develop a bond (see, for example, U.S. Pat. Nos. 5,706,132; 7,862,187; and 4,025,159, all of which are incorporated in their entirety herein). In embodiments in which the multilayer film has no release liner layer and the adhesive layer is facing the embossing tool, the tool may be made of a material that releases well from the adhesive layer and avoids depositing adhesive onto the embossing tool in excess. In some embodiments, the lamination process is controlled to obtain good bonding and sealing between the microreplicated retroreflective elements, body layer, and/or land layer and the multilayer film by controlling such parameters as: embossing tool temperature, pressure between the nip roll and embossing tool (nip pressure), and/or speed of the webs through the process.

In some embodiments, the process involves laminating the entire multilayer film (including at least the adhesive layer and sealing layer) to portions of the structured surface (or microreplicated retroreflective elements), body layer, and/or land layer in a single step. This is advantageous over prior processes in which a seal film was laminated to a retroreflective element-containing film, an adhesive was placed on the seal film in a separate step, and then a release liner was applied to the construction in another separate step. The prior process required two or three separate steps whereas many embodiments of the improved process described herein involve only a single step. Application of adhesive and/or release liner separately from the seal film is more costly than a single-step process. So, the single-step process described herein confers manufacturing efficiency and cost-reduction as well as optionally providing for air egress.

In some embodiments, prior to lamination, an adhesion promoting surface treatment may be applied to either or both of the sealing layer or the structured surface of the microreplicated retroreflective elements. Some exemplary adhesion promotion treatments include, for example, corona treatment, flame treatment, radiation treatment, or application of a thin tie layer or priming layer.

In some embodiments, when the retroreflective article (e.g., sheeting) is to be applied to a substrate (e.g., a metal or plastic substrate for a traffic sign or license plate), the release liner layer (where present) is removed. In some embodiments, this exposes channels in the adhesive layer. These channels have the advantage that air egress (which may be called fluid exhaust or air bleed) from beneath the retroreflective sheeting is facilitated as the sheeting is applied to the substrate. This can help in reducing deformities in the applied sheeting such as air pockets, bubbles, or wrinkles. Retroreflective sheeting as described herein can be applied faster than other sheeting without channels in the adhesive layer because air bubbles and air pockets can be pressed out from beneath the sheeting.

The following examples are not intended to limit the scope of the present disclosure.

### EXAMPLES

The following general procedure was used for the examples. A prismatic retroreflective sheeting was prepared by casting cube corner microstructures (cube corner elements) onto an overlay film, such as described, for example, in U.S. Pat. No. 5,691,846 which is incorporated herein by reference in its entirety. Multilayer films comprising at least a sealing layer and an adhesive layer were laminated to the cube corner microstructure side of prismatic retroreflective sheetings. The specific multilayer films used and retroreflective articles formed are described in greater detail in the following examples.

The cube corner microstructure side of the retroreflective sheeting was laminated to various multilayer films using a laminator 305 mm wide having a rubber nip roll and a heated embossing roll with an embossing or sealing pattern. The retroreflective sheeting and multilayer film were fed through the nip of the laminator rolls. In some embodiments, the multilayer film comprised a releaser liner. In these embodiments, the release liner layer side of the multilayer film contacted the heated embossing roll at temperatures ranging from about 121° to about 204° C. The side of the retroreflective sheeting having the multiplicity of cube corner elements faced the sealing layer side of the multilayer film. The top side (or front surface 21) of the retroreflective sheeting or a carrier film was placed against the heated rubber nip roll which was at about 46° C.

### Examples 1-16

A number of prismatic retroreflective sheetings were laminated to multilayer films having three layers. The overlay film in the prismatic retroreflective sheetings included a PET having a primer composition applied to the surface onto which the cube corner elements were cast onto. The primer used was RHOPLEX 3208. The primed PET film was prepared such as described in, for example, U.S. Patent Publication Nos. 20110019280 (see, paragraphs [0023] through [0038]), and 20110103036 (see. e.g., [0102]), all of which are incorporated herein by reference in their entirety.

The multilayer films comprised: various sealing layer compositions listed below; an adhesive layer comprising a PSA comprising a tackified copolymer of isooctylacrylate and acrylic acid (IOA/AA) in a 95/5 molar ratio; and a release liner layer comprising a co-polyester resin. The sealing layer was prepared by coating with a Mayer rod water based compositions of ethylene copolymers, polyurethane copolymers and acrylic polymers, as shown in Table 1, below, onto the PSA side of a PSA/release liner layer construction. The sealing layer coating was dried by heating the multilayer film to 65° C. for 10 minutes. The cube corner surface of the retroreflective sheeting was subject to corona treatment in air prior to lamination.

The cube corner retroreflective sheeting and the multilayer film were fed to the laminating apparatus comprising the heated embossing tool (roll) and the rubber nip (or back-up) roll. The embossing tool had raised embossments in the shape of a network or pattern of diamond-shaped cells (diamond chain link pattern), the ridges forming the embossments being approximately 0.83 mm wide and 0.92 mm high (as measured from the main surface of the tool). The ridges were approximately 4.9 to 6.4 mm apart from each other.

The multilayer film and retroreflective sheeting were fed to the laminating apparatus at a speed of 3.0 m/min and were subject to a nip pressure of 345 kPa while the embossing roll temperature was 121° C. Retroreflective articles were prepared by laminating the sealing layer side of the multilayer films to the cube corner side of the retroreflective sheetings. All three layers of the multilayer films were embossed.

The retroreflective articles made in this process comprised the retroreflective sheeting having a multiplicity of prismatic, cube corner elements bonded to the multilayer film by seal legs in the grid pattern of the embossing tool. The impressions left by the embossing tool in the multilayer film were evident in the release liner layer of the multilayer film as a network of channels corresponding to the seal legs formed between the multilayer film and the retroreflective sheeting. The cube corner elements were encapsulated within the cells formed by the seal legs.

Preferably, apart from the seal legs, the sealing layer composition forms a good seal with the retroreflective sheeting, but does not touch the cube corner prismatic elements (maintaining an air interface with them), since contact between the sealing layer and the prismatic cube corner elements may adversely affect the brightness of reflected light from the retroreflective product. Nevertheless, the spacing between the sealing layer and the cube corner elements can be very small (e.g., 1 μm) while being sufficient to maintain the needed air interface for reflection.

The following properties of the samples were measured: brightness, percent retention of brightness after lamination with the multilayer film, average seal width (width of the septa), and 90 degree peel adhesion (to test the strength of the bond between the multilayer film and the retroreflective sheeting). Representative test data are shown in Table 1 below. For comparison purposes, a typical value for 90° Peel Test of a commercial cube corner retroreflective sheeting would be about 3.4 lb_{f}.

TABLE 1

| | | Sealing | | Average | 90° Peel |
|---|---|---|---|---|---|
| | | Layer | % Brightness | Seal | Test (lb_{f}) |
| | | Composition | Retention | Width | ASTM |
| Sample | Sealing Layer Resin Type | % Solids | After Sealing | (μm) | D3330 |
| 1 | Ethylene co-terpolymers¹ | 28.3 | 47.2 | 1192 | 2.56 |
| 2 | Ethylene co-terpolymers² | 34.5 | 42.2 | 1374 | 5.22 |
| 3 | Ethylene co-terpolymers³ | 24.8 | 45.6 | 1303 | 5.45 |
| 4 | Ethylene co-terpolymers⁴ | 17 | 43.3 | 1281 | 4.05 |
| 5 | Aliphatic urethane polymers⁵ | 29.4 | 60.4 | 458 | 0.31 |
| 6 | Colloidal polyurethane dispersion⁶ | 34 | 54.8 | 882 | 5.02 |
| 7 | Non-ionic polyester urethane | 40 | 0.9 | 2205 | 3.64 |
| | dispersion⁷ | | | | |
| 8 | Emulsion of aliphatic urethane⁸ | 33 | 79.3 | 452 | 0.66 |
| 9 | Aliphatic polyurethane dispersion⁹ | 37 | 74.2 | 375 | 1.36 |
| 10 | Polyurethane dispersion¹⁰ | 35.5 | 33.4 | 1394 | 7.58 |
| 11 | Emulsion of aliphatic urethane¹¹ | 38.7 | 45.1 | 790 | 7.13 |
| 12 | Polyurethane dispersion¹² | 33 | 36.6 | 1369 | 6.17 |
| 13 | Polyurethane dispersion¹³ | 38 | 75.5 | 494 | 2.76 |
| 14 | Aliphatic urethane¹⁴ | 55 | 49.7 | 1231 | 6.99 |
| 15 | 100% acrylic resin¹⁵ | 40 | 79.5 | 379 | 0.93 |
| 16 | Urethane/acrylic copolymer¹⁶ | | 77.3 | 391 | 1.10 |

¹Obtained as Michem 5931 from Michelman, Inc., Cincinnati, Ohio.
²Obtained as Michem 4990R from Michelman.
³Obtained as Michem 4938R from Michelman.
⁴Obtained as Michem 2960 from Michelman.
⁵Obtained as NeoRez R-9603 from DSM Neo Resins Inc., Wilmington, Massachusetts.
⁶Obtained as NeoRez R-972 from DSM Neo Resins.
⁷Obtained as NeoRez R-9330 from DSM Neo Resins.
⁸Obtained as NeoRez R-966 from DSM Neo Resins.
⁹Obtained as NeoRez R-9679 from DSM Neo Resins.
¹⁰Obtained as NeoRez R-551 from DSM Neo Resins.
¹¹Obtained as NeoRez R-967 from DSM NeoResins.
¹²Obtained as NeoRez R-600 from DSM Neo Resins.
¹³Obtained as NeoRez R-650 from DSM Neo Resins.
¹⁴Obtained as NeoCryl A-1120 from DSM Neo Resins.
¹⁵Obtained as NeoCryl A-550 from DSM Neo Resins.
¹⁶Obtained as NeoPac R-9009 from DSM Neo Resins.

The above data show that samples with smaller seal width (less than 500 micrometers) have lower peel strength and higher initial brightness retention after sealing. The sealing layer of sample 7 contacted the cube corner elements on the back side of the retroreflective sheeting resulting in poor brightness retention. All samples were characterized for good air egress by virtue of the channels in the adhesive layer. From the standpoint of the combination of characteristics (e.g., retaining brightness after sealing, average seal width, and strength of bond between the multilayer film and the retroreflective sheeting) the preferred samples are numbers 4, 6, 10-12 and 14.

### Examples 17-20

A retroreflective sheeting 305 mm wide having a multiplicity of cube corner elements on one side, and comprising a body layer comprising an ethylene acrylic acid (EAA) copolymer and cube corner elements comprised of a nitrogen-containing acrylate resin curable by ultraviolet radiation, as described in U.S. Pat. No. 7,862,187 (examples), was laminated to four different multilayer films as described: Example 17—sealing layer comprising a blend of acid/acrylate modified EVA copolymer (obtained as Bynel resin from DuPont), copolymer of ethylene, vinyl acetate and carbon monoxide obtained as Elvaloy resin from DuPont and acrylic polymer.(Paraloid B-67 resin from Dow Chemical Co., Midland, Mich.); a layer of white pigmented linear low density polyethylene (LLDPE); a tie layer comprising a copolymer of ethylene and acrylic acid; a PSA layer comprising 2-methylbutylacrylate and acrylic acid in a 96/4 molar ratio; and a 3-layer release liner layer having a first layer facing the adhesive comprising Infuse olefin block copolymer (from Dow Chemical Co.), a core layer comprising HDPE, and an HDPE back side layer.

Example 18—sealing layer comprising two layers, a pigmented polyurethane receptor layer and a maleic anhydride modified HDPE, a layer of white pigmented HDPE; tie layer comprising HDPE modified with polyether block amide (obtained as Pebax from Arkema, Paris, France); PSA layer made by melt blending two polymers, each produced by bulk polymerization within a polymeric (e.g., polyethylene) pouch initiated by ultraviolet radiation according to the methods described in WO 9607522, the first polymer derived from a mixture of 90 parts by weight 2-ethyl hexyl acrylate and 10 parts acrylic acid and the second polymer derived from a mixture of 75 parts by weight 2-ethyl hexyl acrylate, 15 parts by weight methyl acrylate and 10 parts N,N-dimethyl acrylamide, the blend having equal parts by weight of the first and second polymers; and a 2-layer release liner layer having a first layer facing the adhesive comprising ultra low density Infuse olefin block copolymer and a back side layer comprising HDPE.

Example 19—sealing layer comprising a blend of thermoplastic polyurethane and acrylic polymer, an adhesive layer like that in Example 18, and a three-layer release liner layer having a first layer facing the adhesive comprising ultra low density polyethylene (LDPE) resin, an HDPE core layer and an HDPE back side layer.

Example 20—sealing layer comprising acid/acrylate-modified ethylene vinyl acetate polymer (Bynel 3101 polymer from DuPont), an HDPE layer, a tie layer comprising HDPE modified with Pebax polyether block amide, adhesive layer like that of Example 18, and a two-layer release liner layer having a first layer facing the adhesive comprising block copolymer of ethylene and alpha olefin (Infuse olefin block copolymer from Dow Chemical) and an HDPE back side layer.

The multilayer films in all four examples (17-20) were made by co-extruding the layers in a film extrusion process. One exemplary film extrusion process is described in U.S. Pat. No. 6,921,729 (see, for example, columns 8 and 13-14 and FIG. 5) (incorporated herein in its entirety). Another exemplary film extrusion process is described in U.S. Publication No. 2011/031620, incorporated herein in its entirety.

Each multilayer film was laminated to the side of a retroreflective sheeting having a multiplicity of cube corner elements in a laminating apparatus that embossed (or impressed) a network (or grid pattern) into the multilayer film and bonded the multilayer film to the retroreflective sheeting under the same conditions of temperature, nip pressure and web speed as described above for Examples 1-16. The retroreflective sheeting was placed on the nip (or back-up) roll with the front surface 21 facing the roll, and the multilayer film was fed into the apparatus with the release liner layer facing the embossing tool.

Of the four examples (17-20) the products of examples 17 and 20 exhibited better bonding and sealing between the multilayer film and the retroreflective sheeting than examples 18 and 19. The retroreflective brightness (coefficient of retroreflection, Rₐ, measured at 0.2° observation angle and −4° entrance angle) of the products of Examples 17 and 20 were measured, and the data from Example 17 ranged from 609 to 741 candelas/lux/m² at 0° orientation. Brightness data for example 20 were 523-540 candelas/lux/m² at 0°.

Samples from examples 17 and 20 were tested for air egress (air bleed) and both were adequate; although, the sample from example 17 was much better. Such good air egress would be a benefit in removal or prevention of air pockets underneath a large sign made from the retroreflective sheeting as it is applied to a substrate. A control sample of commercially available cube corner reflective sheeting (without channels in its release liner and adhesive layer) was also tested for air egress, and there was no detectable air bleed (air flow) found from beneath the applied sheeting.

If cube corner retroreflective articles are made with a specular reflective coating, such as a metallic coating, on the cube corner prismatic surfaces, a sealing layer is optional since an air interface is not required for total internal reflection. A metallic coating can be applied by means known in the art such as vapor deposition or chemical deposition (e.g., electroless coating) of a metal such as silver, aluminum or nickel. A primer layer may be applied to the cube corner elements to promote adherence of the metallic coating. A multilayer film may be applied to such cube corner retroreflective articles as taught hereinabove; but, the sealing layer would be optional. In this one specific embodiment, the process described above would be followed, except that the multilayer film would comprise an adhesive layer and a release liner layer adjacent the adhesive layer as described above, but there would be no polymeric sealing layer.

All references mentioned herein are incorporated by reference in their entirety.

As used herein, the words “on” and “adjacent” cover both a layer being directly on and indirectly on something, with other layers possibly being located therebetween.

As used herein, the terms “major surface” and “major surfaces” refer to the surface(s) with the largest surface area on a three-dimensional shape having three sets of opposing surfaces.

Unless otherwise indicated, all numbers expressing feature sizes, amounts, and physical properties used in the present disclosure and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. All numerical ranges are inclusive of their endpoints and non-integral values between the endpoints unless otherwise stated.

As used in this specification and the appended claims, the singular forms “a”, “an”, and “the” encompass embodiments having plural referents, unless the content clearly dictates otherwise.

As used in this disclosure and the appended claims, the term “or” is generally employed in its sense including “and/or” unless the content clearly dictates otherwise.

The phrases “at least one of” and “comprises at least one of” followed by a list refers to any one of the items in the list and any combination of two or more items in the list.

Various embodiments and implementation of the present disclosure are disclosed. The disclosed embodiments are presented for purposes of illustration and not limitation. The implementations described above and other implementations are within the scope of the following claims. One skilled in the art will appreciate that the present disclosure can be practiced with embodiments and implementations other than those disclosed. Those having skill in the art will appreciate that many changes may be made to the details of the above-described embodiments and implementations without departing from the underlying principles thereof. It should be understood that this invention is not intended to be unduly limited by the illustrative embodiments and examples set forth herein and that such examples and embodiments are presented by way of example only with the scope of the invention intended to be limited only by the claims set forth herein as follows. Further, various modifications and alterations of the present disclosure will become apparent to those skilled in the art without departing from the spirit and scope of the present disclosure. The scope of the present application should, therefore, be determined only by the following claims.

1-34. (canceled)

35. A retroreflective article, comprising:
a plurality of microreplicated retroreflective elements that are at least one of (a) prismatic elements or (b) lenslets; and
a multilayer film adjacent to the microreplicated retroreflective elements and comprising a polymeric sealing layer and an adhesive layer; and
seal legs extending through all layers of the multilayer film;
channels depressed in at least a portion of the multilayer film at the seal legs.

36. The retroreflective article of claim 35, wherein the prismatic elements are at least one of truncated cube corner elements, PG cube corner elements, and full cube corner elements.

37. The retroreflective article of claim 35, wherein the microreplicated retroreflective elements are adjacent to at least one of a land layer or a body layer.

38. The retroreflective article of claim 37, wherein the seal legs extend between the multilayer film and at least one of the microreplicated retroreflective elements, the land layer, or the body layer.

39. The retroreflective article of claim 25, wherein the prismatic elements include a thermoplastic polymer.

40. The retroreflective article claim 35, further comprising an air interface between at least some of the microreplicated retroreflective elements and the multilayer film.

41. The retroreflective article of claim 35, wherein the channels are depressed in at least a portion of the adhesive.

42. The retroreflective article of claim 35, further comprising:
a release liner layer adjacent to the adhesive layer.

43. The retroreflective article of claim 42, wherein the multilayer film further comprises the release liner adjacent to the adhesive layer.

44. The retroreflective article of claim 43, wherein the channels are depressed in at least a portion of the adhesive and the release liner.

45. The retroreflective article of claim 42, wherein the release liner comprises a release layer facing the adhesive layer and an outer layer having a composition to reduce blocking.

46. The retroreflective article of claim 42, wherein the release liner comprises a release layer comprised of very low density polyethylene, and an outer layer comprised of a polyethylene that is not very low density polyethylene.

47. The retroreflective article of claim 46, wherein the outer layer includes at least one of polypropylene, polyethylene, or polyethylene terephthalate.

48. The retroreflective article of claim 35, wherein the polymeric sealing layer includes at least one of a thermoplastic polymer, a heat activated polymer, a polymer composition curable by ultraviolet radiation, and a polymer composition curable by ionizing radiation.

49. The retroreflective articles of claim 35, wherein the microreplicated retroreflective elements are coated with a specular reflective coating

50. A process of making a retroreflective article, comprising:
laminating a multilayer film adjacent to a plurality of microreplicated retroreflective elements and thereby forming a plurality of seal legs that extend through all layers of the multilayer film and forming channels depressed in at least a portion of the multilayer film at the seal legs;
wherein the multilayer film comprises a polymeric sealing layer and an adhesive layer; and
wherein the microreplicated retroreflective elements comprise at least one of prismatic elements and lenslets.

51. The process of claim 50, wherein laminating the multilayer film includes bonding the multilayer film to the plurality of microreplicated retroreflective elements by at least one of ultrasonic welding, radio frequency welding, thermal bonding, ultraviolet radiation, and electron beam radiation.

52. The process of claim 50, further comprising:
forming the multilayer film using solution casting, extrusion casting, blown film extrusion, or any combination thereof.

53. The process of claim 50, wherein the prismatic elements are at least one of truncated cube corner elements, PG cube corner elements, and full cube corner elements.

54. The process of claim 50, wherein the microreplicated retroreflective elements are adjacent to at least one of a land layer or a body layer.

55. The process of claim 54, in which the seal legs extend between the multilayer film and at least one of the microreplicated retroreflective elements, the land layer, or the body layer.

56. The process of claim 50, in which the microreplicated retroreflective elements include a thermoplastic polymer.

57. The process of claim 50, wherein laminating the multilayer film adjacent to the plurality of microreplicated retroreflective elements forms an air interface between at least some of the microreplicated retroreflective elements and the multilayer film.

58. The process of claim 50, wherein the multilayer film further comprises a release liner layer adjacent to the adhesive layer.

59. The process of claim 58, wherein the release liner layer is comprised of two layers, a release layer facing the adhesive layer and an outer layer having a composition to reduce blocking.

60. The process of claim 58, wherein the release liner layer comprises a release layer comprised of very low density polyethylene, and an outer layer comprised of a polyethylene that is not very low density polyethylene.

61. The process of claim 59, wherein the outer layer includes at least one of polypropylene, polyethylene, or polyethylene terephthalate.

62. The process of claim 50, wherein the polymeric sealing layer includes at least one of a thermoplastic polymer, a heat activated polymer, a polymer composition curable by ultraviolet radiation, or a polymer composition curable by ionizing radiation.

63. The process of claim 50, wherein the microreplicated retroreflective elements are coated with a specular reflective coating.

64. The process of claim 50, further comprising:
co-extruding the sealing layer and adhesive layer in a single step to form the multilayer film.
